(19) United States
(12) Patent Application Publication
(10) Pub. No.: US 2019/0147501 A1
(43) Pub. Date: May 16, 2019

(54) LAYOUT DEVICE OF CALENDAR AND ADVERTISEMENT, PRINTED PUBLICATION AND WEB DISTRIBUTION SYSTEM

(71) Applicant: CALENDAR KOKOKU CO., LTD., Osaka-shi, Osaka (JP)

(72) Inventor: Yutaka HIRAHARA, Osaka-shi, Osaka (JP)

(21) Appl. No.: 16/300,919

(22) PCT Filed: Apr. 27, 2017
(86) PCT No.: PCT/JP2017/016797

§ 371 Date: Nov. 12, 2018

(30) Foreign Application Priority Data
May 13, 2016 (JP) 2016-096898

(51) Int. Cl. G06Q 30/02; G09F 23/10; B42D 5/04

(52) U.S. Cl. CPC G06Q 30/0276; G06Q 30/0257; B42D 5/047; G09F 23/10; B42D 5/046; G06Q 30/0277

(57) ABSTRACT

Advertisements of commodity or service of companies and stores are not easily delivered to customers and readers. Even when the advertisements are delivered with difficulty, the advertisements are lost or discarded without being stored for a long period. Thus, the advertisements are hardly memorized. When conventional four types of mass communication are used, cost effectiveness is poor. When an Internet media is used, it is difficult to attract an attention. Thus, advertising technology capable of exposing individual advertising material while being connected with printing medium and Internet medium is required to cause an action. Calendar numbers are regarded as an advertising medium, advertisements and a calendar are printed integrally on both sides of pages and published. To achieve this, a layout format of combined advertisement for laying out advertisement frames having page numbers or calendar numbers is provided so that the advertisements are invited and laid out on a blank page located at a reverse side of a calendar page. A new advertisement tool is provided to create and bind a catalog calendar (registered trademark) which is an information medium for keeping good relation with customers. A frame number inserted in the advertisement frames is converted to an advertisement number or a commodity/service number. In addition, the calendar numbers and advertisement date numbers are printed on the both sides of the paper and uploaded on the Internet while being in association with each other. Thus, printing, publishing, Internet delivery and commercial transaction are secured by smooth editing technology.

### TECHNICAL FIELD

The present invention relates to editing and advertising technology for laying out, printing, binding and distributing a printed publication and distributing advertisement information of a guide list of commodities and services of a company and a shop on the Internet by using a calendar as an intermediary.

### BACKGROUND ART

In an advertisement form of a desktop calendar or a wall hanging calendar printed in every year, a calendar-with-name formed by printing a name of a company or a store on a blank space of the page including calendar numbers and a calendar formed by placing photographs, guide texts or the like on a calendar page or a reverse side of the page is distributed with or without charge.

Note that a binding tool of calendar, a printed material and a media technology are described in Patent Documents 1 to 4.

### PRIOR ART DOCUMENTS

### Patent Documents

[Patent Document 1] Japanese Patent No. 5721120 (PCT/JP2015/67099)

[Patent Document 2] Japanese Patent No. 5416855 (PCT/JP 2013/84790)

[Patent Document 3] Japanese Patent No. 5021059 (PCT/JP 2010/63433)

[Patent Document 4] Japanese Patent No. 4913253

### DISCLOSURE OF THE INVENTION

### Problems to be Solved by the Invention

However, it is not easy to widely distribute and advertise the guide information related to the name, commodity, service and the like of the company, store, organization and the like to many unspecified people by using an independently created calendar.

Therefore, advertising technology using the calendar numbers is required for editing, printing, publishing, distributing and delivering classified advertisements, catalog information and the like of a plurality of companies and stores in association with an advertising term. To merely print advertisements on a reverse side of the calendar page is disclosed in Japanese Patent No. 4913253, for example. However, there is no technology to specifically disclose how to lay out the advertisements on the printed publication including the calendar page. Furthermore, there is no technology at all in the past to form advertisement pages by assigning frame numbers corresponding to page numbers to advertisement frames for laying out the advertisements while the advertisement pages are in association with the calendar of the calendar page.

Accordingly, the present invention aims for providing a printed publication, a web distribution system, and a layout format, a layout device and a layout method of the printed publication, for easily editing, printing, publishing, distributing and delivering the advertisement information of the company, store, organization and the like.

### Means for Solving Problem

Conventionally, the reverse side of paper of a wall hanging calendar is blank, and the advertisements are not placed on the reverse side which are not seen. In some rare cases, avocational photographs and texts are printed on the reverse side of the paper by arranging a binding portion at an upper side. However, there is no industrially applicable technology. For a customer and a reader, the advertising material is annoying and the customer and the reader want to see the advertising material only when needed.

Good advertisement achieves five stages of AIDMA (attention, interest, desire, memory and action). Thus, the advertisements on the calendar paper are stored for a long period to bear good fruits.

Even when information magazine or advertising booklet of commodity catalog is given to the customer and the reader, the information magazine or the advertising booklet is immediately lost or discarded. As a means for preventing that, the present invention provides a printed publication simultaneously having a calendar and advertisements in 64 pages of 32 sheets of paper.

In the present invention, advertisements of commodities or the like are edited and printed on a reverse side of calendar pages, front and rear of blank pages or the like as a catalog. In a daily booklet of a monthly magazine, 33 pages can be secured for advertisement pages (printing pages 64−calendar pages 31=advertisement pages 33). In a monthly calendar booklet of an annual magazine, 51 pages can be secured for advertisement pages (printing pages 64−monthly calendar pages 12=advertisement pages 51). In a booklet simultaneously having monthly calendar pages and daily calendar pages, 21 pages can be secured for advertisement pages (printing pages 64−monthly calendar pages 12−daily calendar pages 31=advertisement pages 21). Here, the advertisement pages are the space for placing the advertisements/space for printing media.

In a booklet of 365 sheets of daily calendar, the space of the media of the advertisement pages is 365 pages.

Suppose that the advertisements of commodity or service of the company or the store are laid out and printed by assigning four frames per one page, 132 advertisements (33 pages×4 companies), 204 advertisements for 51 pages, and 84 advertisements for 21 pages can be placed on one printed publication. In the daily calendar booklet, 1460 advertisements (365 pages×4 companies) can be placed on one printed publication.

Since the conventional daily booklet formed by binding 365 sheets of paper is heavy, manufacturing cost is increased, advertisement information is obsoleted, and the customer and the reader become estranged for a long period. Thus, it is preferred that the booklet is published as a quarterly magazine of spring, summer, fall, and winter, a publication for a plurality of months or monthly publication in addition to the annual magazine.

Suppose that the advertisement rate per one advertisement is 10,000 Japanese Yen, an income of the advertisement rate can be obtained 840,000 Japanese Yen for 21 pages, 1,320,000 Japanese Yen for 33 pages, 2,040,000 Japanese Yen for 51 pages, 3,360,000 Japanese Yen for 84 pages, and 14,200,000 Japanese Yen w for 365 pages. Thus, it is enough even when a considerable number of printed publications are distributed free of charge.

Accordingly, blank space presented on the reverse page of the calendar page is formed as an information medium of advertisement industry. Thus, a layout format for laying out a plurality of advertisements is provided to advertising sponsors, advertising agencies and editors.

In order to form an advertising medium having a mechanism of advertisement and promotion by using a calendar booklet as an intermediary, a layout format of the advertisements is provided for laying out a plurality of frame-shaped advertisement frames which determine a layout for laying out and placing a plurality of advertisements of the sponsors on the booklet separately by size and category.

The frame numbers are provided by numbering the advertisement frames using the page numbers of binding and gathering. Thus, smooth editing process can be secured for the editor and publication of the advertisement contents can be managed as a commodity and a copyright.

When the printed publication is provided to the users and readers, the binding orientation of the printed publication is specified so that the advertisements are laterally opened to be easily viewed and read and the calendar numbers are vertically opened.

The calendar of the next year is delivered to the readers who response to the advertisements or purchase the commodity at least once.

For example, when the advertisements of magazines and books are placed as the advertisements of the printed publication, advertisement data is created based on a book title, an ISBN number, an author name, a publishing company, a content explanation, a price or the like of the advertisements, and then the advertisement data is inserted into the advertisement frame forming a layout format of the advertisement based on the frame number. Thus, the frame number is newly displayed as an advertisement number. Furthermore, the printed publication is formed while the number (e.g., ISBN number) for identifying the book is displayed. Because of this, the commodity can be ordered by the ISBN number identifying the book or the advertisement number.

When the advertisement number or the ISBN number identifying the book displayed on the printed publication is distributed on the Internet, the users can purchase the printed publication or the electronic publication of the corresponding magazine and book by Internet search. Because of this, attention→interest→desire→memory→action are achieved. Furthermore, it is advantageous for the users if an invitation ticket of an event for selling the book by the author is printed on the reverse side of the paper of a desktop-type calendar or a wall hanging-type calendar.

When job offer advertisements of the company or the store are placed as the advertisements of the printed publication, the advertisement data is created based on a trade name, a business category, a job, an adoption condition, a recruitment number or the like of the company or the store (i.e., advertising sponsor), and then the advertisement data is inserted into the advertisement frame forming a layout format of the advertisement based on the frame number. Accordingly, the frame number is displayed after it is converted into the advertisement number. Furthermore, the printed publication is formed while the recruitment number is displayed. Because of this, the recruitment information can be identified by the advertisement number or the recruitment number.

Since all companies permanently seek superior human resources, the job offering company and the job applicant are matched with each other by distributing the advertisement number or the recruitment number of the job offer advertisement on the Internet. Because of this, attention, interest, desire, memory and action are achieved. Furthermore, it is further advantageous for the job offering companies, the job applicants and the readers if the advertising agency of the job offering company and the name of the company of offering job are further placed on the reverse side of the calendar page.

In a binding portion of the printed publication, binding means is selected according to the quantity of manufacture of the calendar, advertisement contents and favor of the sponsor. A perfect binding using a metal fitting and an adhesive liquid, a saddle stitching using a wire or a means of using a wire ring can be selected, for example. In addition, a wall hanging-type file binder disclosed in Patent Document 2: Japanese Patent No. 5416855 and a desktop-type file binder (Calenda HANGER, Registered trademark) disclosed in Patent Document 3: Japanese Patent No. 5021059 can be selected. The above described file binders are suitable for applying the present invention since the pages can be easily replaced, added and removed.

As a paper processing of the printed publication, hook holes used for hanging the booklet on a wall surface are provided. In addition, cut lines (perforation lines) are provided for cutting the paper below the hook holes. Thus, coupons and order sheets prepared on the advertisement pages can be cut off.

In the printed publication, the calendar number of the calendar page and advertisement date number (number of advertisement date) of the advertisement page are in association with each other to be placed on the front and rear sides. Furthermore, vertical and horizontal cut lines (perforation lines) are provided so that the readers can separately cut off only the advertisement printed on the reverse side of the corresponding calendar number. For example, it is further advantageous for the users if a leaflet, a ticket, a discount coupon or the like having a deadline of the current date or the current month is printed on the reverse side of the daily calendar page cut off on the corresponding date.

In order to form an advertising medium having a mechanism of advertisement and promotion by using the calendar numbers of the calendar page as an intermediary, the advertisement date numbers displayed on the advertisement data and the advertisement date numbers of the advertisement information distributed from Internet server are laid out on the paper while being in association with each other in the process of editing the advertisement. For example, event information corresponding to the date of a store/business-opening day, an anniversary day and a store/business closing day of the company, store and organization is printed and placed on the advertisement page corresponding to the monthly or daily calendar page. Furthermore, in a distribution system including the Internet server, the sponsor side terminal and the user side terminal, the event information is also entered in 365 cells of the calendar numbers provided in a calendar data stored in the Internet server so as to be viewed from the user side terminal. Consequently, the event information and the date of the event are provided to the customers and the readers commonly from both media of the printed publication and Internet communication terminal. In addition, the advertisements of the scheduled date of movie or concert can be provided from both media of the printed publication and Internet communication terminal as described above.

It is advantageous for the users and the readers if the attention of the event information having the deadline of the current date is made by the printed publication and a mobile terminal and the action is made by cutting the reservation ticket.

In addition, it is advantageous for the advertising sponsors if the schedule and guide of the store/business-opening day, the anniversary day and the store/business closing day can be posted on the Internet and printed on the printed publication such as a desktop calendar and a wall hanging calendar.

Note that the technology of an internet distribution system using the calendar as an intermediary and the technology of associating the calendar numbers with the advertisements are not described in detail since they are disclosed in Patent Document 1: Japanese Patent No. 5721120 (PCT/JP2015/67099).

### Effects of the Invention

By providing the layout format of the printed publication for laying out the calendar pages and the advertisement pages as described in the above described embodiment, the catalogs and classified advertisements for advertising and promoting the companies and the stores can be easily and inexpensively printed, published and distributed. The advertisements which are stored and remembered by the readers for a long period without being lost or discarded easily can be provided. The customers can obtain the calendar having useful information without having the annoying advertisements on the front pages.

By using the desktop-type and wall hanging-type binding means capable of replacing the pages of the printed matters described in the above described Patent Documents as the means for binding the printed publication of the present invention, distribution costs of the traded advertisement product can be reduced.

By laying out the advertisements of commodity, service or the like (e.g., a catalogue of books for guiding the books) on the layout format of the printed publication and distributing the same catalogue on the Internet using the Internet server, commercial transaction can be made by both the printed publication and the Internet distribution by using the common advertisement numbers.

In addition, as a means for widely guiding and advertising the date of holding a celebration event of the store/business-opening day, the anniversary day and the store/business closing day of the company and the store to the society, the calendar date of holding the event is exposed by the common number displayed on the advertisement delivered on the Internet and the advertisement distributed by the printed publication. Thus, the functions of both media are shared and compensated with each other. Consequently, synergistic advertisement effect can be obtained.

Because of the progress of the communication technology and the printing technology of the present day, the media formed by integrating the advertising technologies of book publishing and Internet communication can be adopted by using the calendar numbers as an intermediary. Thus, new market can be created for the advertising industry.

### BRIEF DESCRIPTION OF THE DRAWINGS

FIG. 1 is a drawing showing a configuration of bookbinding of calendar pages and advertisement pages in a printed publication concerning the first embodiment.

FIG. 2 is a drawing showing a layout format of the advertisement pages.

FIG. 3 is a drawing showing an example of a page layout of the calendar pages and the advertisement pages.

FIG. 4 is a drawing showing an example where calendar numbers of the calendar pages and advertisement date numbers are in association with each other and printed on both sides of paper in a printed publication concerning the second embodiment.

FIG. 5 is a drawing showing a relation among the calendar numbers of the calendar pages, the advertisements of the advertisement pages and cut lines in a printed publication concerning the third embodiment.

FIG. 6 is a drawing showing a distribution system that mediates the advertisement of the printed publication with the advertisement delivered on the Internet using the calendar numbers.

FIG. 7 is a block diagram schematically showing a layout device for laying out the printed publication using the layout format.

### MODES FOR CARRYING OUT THE INVENTION

Hereafter, the embodiments of the present invention will be explained with reference to the drawings.

Same reference numerals are added to the components forming the printed publication, the calendar pages and the advertisement pages.

### First Embodiment

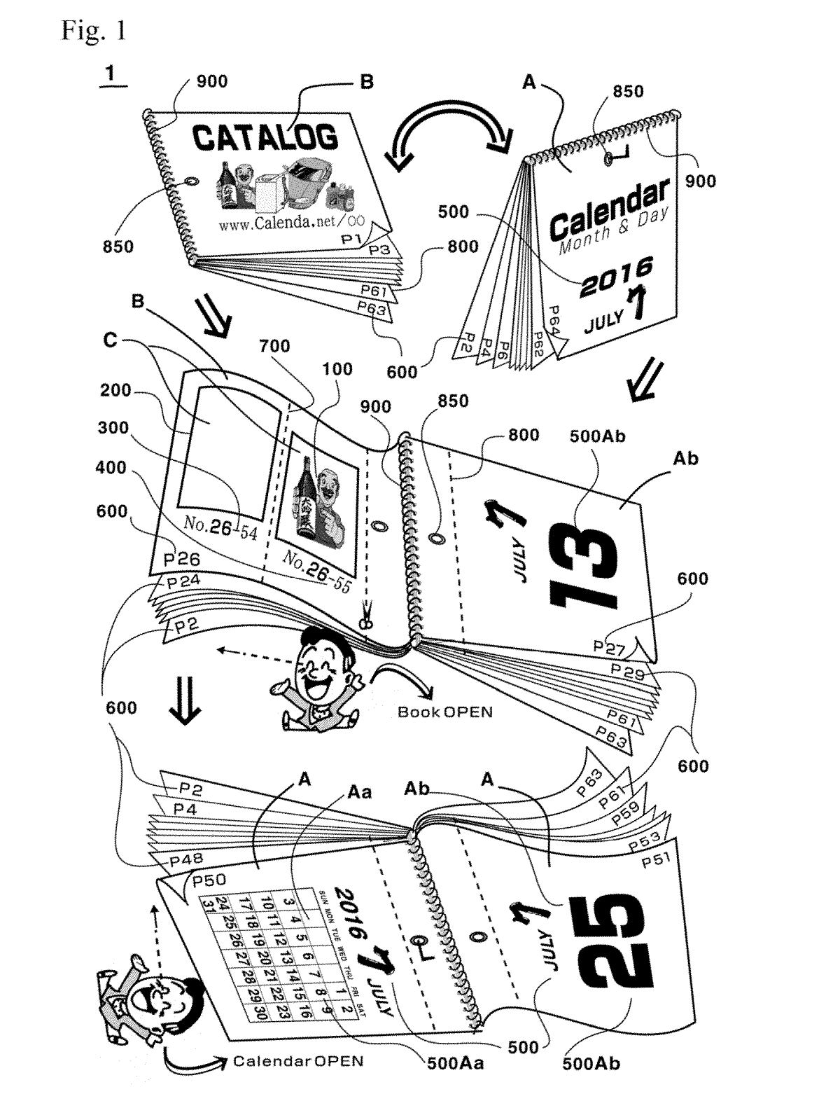

FIG. 1 is a drawing showing a configuration of bookbinding of calendar pages A and advertisement pages B concerning the first embodiment. As shown in FIG. 1, a printed publication 1 is formed by performing printing on 64 pages of both sides of 32 sheets of paper and binding the paper. The printed publication 1 is formed by the calendar pages A and the advertisement pages B. The advertisement pages B are printed on the reverse side of the calendar pages A or both sides of a paper on which the calendar page A is not printed. The calendar page A includes two kinds of pages: one is monthly calendar pages AA and the other is daily calendar pages AB. However, the calendar pages can be formed by one of the monthly calendar pages AA and the daily calendar pages AB. Alternatively, the calendar pages can be formed by using both the monthly calendar pages AA and the daily calendar pages AB. In addition, the number of the papers can be arbitrarily changed without limited to 32 sheets. The number of the papers is preferably at least 6 sheets (12 pages) in order to print twelve months of the monthly calendar pages. Note that the advertisements can be inserted in a blank space of the calendar pages AA or the calendar pages AB. As an example of the printed publication 1, a booklet, a magazine and a book can be listed, for example.

A wire ring-type binding portion 900 is provided on the printed publication 1 so that the binding portion 900 is arranged between the left and right ends of an upper part of the printed publication when the printed publication 1 is seen by aligning the printed publication 1 in the printing direction of the calendar pages A. The wire ring-type binding portion 900 binds one end of the printed publication 1 to form a booklet by inserting spirally formed wire into a plurality of holes passing through the sheets of the printed publication 1. The form of the binding portion 900 is not limited to the wire ring-type. For example, a wall hanging-type file binder described in Patent Document 2 and a desktop-type file binder described in Patent Document 3 can be used as the binding portion 900. In addition, conventionally known various binding members such as a saddle stitching using a wire or a thread and a perfect binding using an adhesive liquid can be used, for example. Other than the above described examples, conventionally known various binding methods can be used.

Hook holes 850 are provided at the position below the binding portion 900 and neighboring the binding portion 900. The hook holes 850 are arranged at an approximately center in the width direction of the calendar pages A. The hook holes 850 are provided at the same position in all pages forming the printed publication 1. Thus, the hook holes 850 penetrate through all pages when the printed publication 1 is bound. The printed publication 1 can be hooked on the wall by inserting the hook holes 850 into a projection or the like formed on the wall. The number of the hook holes 850 can be one, two or more. In addition, it is also possible not to provide the hook holes 850.

Cut lines (perforation lines) 800 are formed at the position below the hook holes 850 and neighboring the hook holes 850. The cut lines 800 are formed on each page of the printed publication 1. The cut lines 800 are an intermittent cut formed to cross from one end of the page to the other end. A part of the page can be removed from the printed publication 1 without using scissors by holding one side of the cut lines 800 as a boundary and applying force of turning the other side.

The calendar pages AA are a monthly calendar. The calendar pages AA include calendar numbers 500 and page numbers 600. The calendar numbers 500 of the calendar pages AA include the indication of all dates and days of the week of one month in addition to the indication of year and month. The calendar pages AB are a daily calendar. The calendar pages AB include calendar numbers 500 and page numbers 600. The calendar numbers 500 of the calendar pages AB include the indication of the month and date of one day. The configuration of the calendar pages AA and the calendar pages AB is not limited to the above described form. The display format of conventionally known various calendars can be also used. For example, days of the week can be further indicated on the daily calendar pages AB. Alternatively, only the date can be indicated without indicating the month. Accordingly, the book bound by a ring where the pages indicating the date numbers up to 31 are rotatably bound becomes a daily calendar which can be repeatedly used for each month/year.

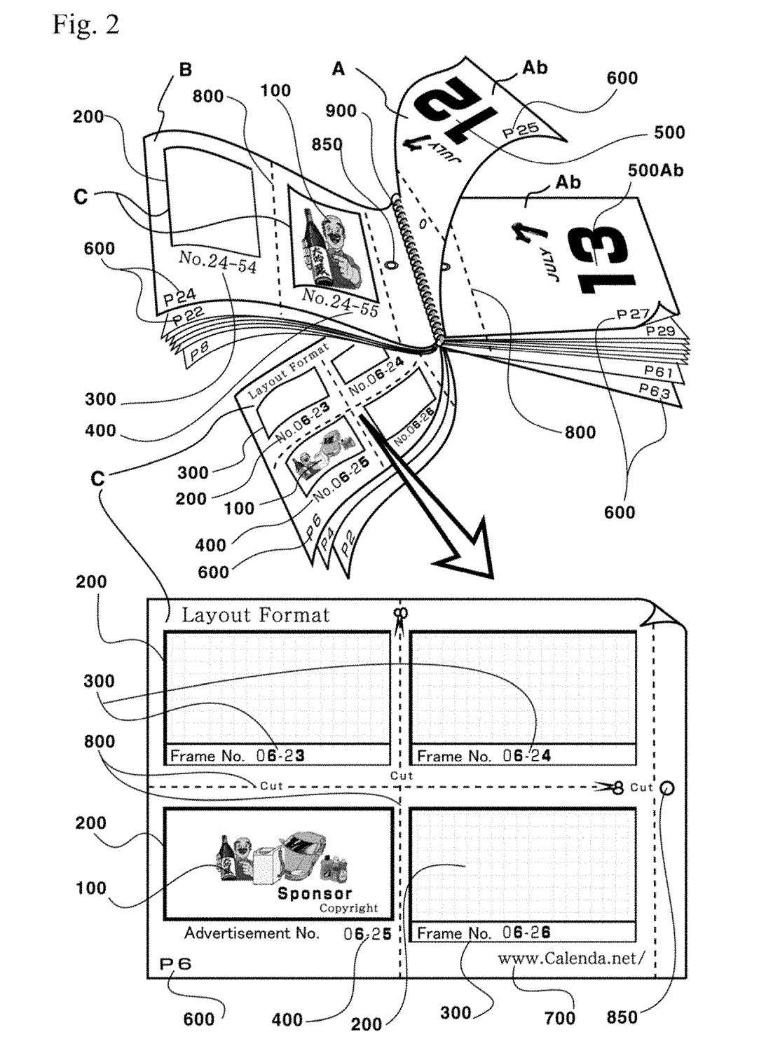

The page numbers 600 are continuous numbers assigned one by one to each page forming the printed publication 1. The page numbers 600 are assigned to each page continuously from the cover page of one side of the printed publication 1 after the printed publication 1 is gathered and bound without discrimination between the calendar pages A and the advertisement pages B. It is not necessary to actually print the page numbers 600 on the calendar pages A and the advertisement pages B. However, even when the page numbers 600 are not printed on the pages, the page numbers 600 are assigned to each page on a layout format C shown in FIG. 2. Furthermore, same numbers and additional numbers are assigned over a plurality of pages.

The advertisement pages B include advertisement frames 200, frame numbers 300 and the page numbers 600.

The advertisement frames 200 are frames for laying out the advertisements on the layout format C when performing an operation of laying out the advertisement pages B on the layout device D. One advertisement is laid out on one advertisement frame 200. When a plurality of advertisements is laid out on one page, the advertisement frame is provided in plural number. The position and the size of each of the advertisements are determined according to the position and the size of the advertisement frame. The frame numbers 300 are assigned to each of the advertisement frames 200. The frame numbers 300 are numbers for identifying the advertisement frames 200. The advertisement frames 200 and the frame numbers 300 correspond one-to-one with each other.

When receiving a request to place the advertisement from the advertising sponsor, the frame number 300 corresponding to the position to place the advertisement is assigned to the data of an advertising material 100. Thus, the advertising material 100 is arranged on the advertisement frame 200 at the position corresponding to the frame number 300. Namely, the advertisement frame 200 to which the advertising material 100 is arranged is identified by the frame numbers 300. When the advertising material 100 is laid out on (fitted to) the advertisement frame 200, the frame number 300 is arranged on the advertisement page B as an advertisement number 400 so as to be printed. Namely, the frame number 300 is converted into the advertisement number 400 and arranged on the advertisement page B. Since the advertisement number 400 is printed, the placed advertisement can be easily identified even after published as the printed publication 1.

As described above, a plurality of requests to place the advertisement from the advertising sponsors can be received by arranging a plurality of advertisement frames 200. In addition, a lineup of the commodity or service can be displayed as a list. Accordingly, the advertisement pages B function as a catalog or a guide book.

The page numbers 600 are also assigned to the advertisement pages B, same as the calendar pages A. In the advertisement pages B, the page numbers 600 are included in a part of the frame numbers 300 so that the page numbers 600 and the frame numbers 300 are in association with each other by numbering. Therefore, the advertisement frames 200 can be numbered by using the page numbers 600 which is the numbers used after the book is bound. In addition, the editor (operator) can smoothly lay out the advertising material 100 on the layout format C. Furthermore, the advertising material 100 can be easily managed as a content. The advertisement corresponding to the content of the calendar number of the calendar page A can be laid out on the advertisement page B by identifying the advertisement frame 200 using the frame numbers 300 including the page numbers 600 since the calendar pages A can be more easily identified by the frame numbers 300 than the page numbers 600.

When a plurality of advertising materials 100 is placed on one advertisement page B, the cut lines 800 can be further added in addition to the cut lines 800 just below the hook holes 850. If the cut lines 800 are added, a plurality of advertising materials 100 can be separately cut.

As shown in the middle part of FIG. 1, the advertisement pages B are printed so that the binding portion 900 of the book is located on the right side and the book is laterally opened when the printed publication 1 is seen by aligning the printed publication 1 in the printing direction of the advertisement pages B. Namely, the advertising materials of the advertisement pages B are oriented to be laterally opened when the printed publication is bound. By forming the advertisement pages B to be opened laterally, only the advertisement pages B of the printed publication 1 can be read as if a catalog booklet is read. Note that the advertisements can be printed so that the binding portion 900 of the laterally opened book is located on the left side.

As shown in the lower part of FIG. 1, the calendar pages A are printed so that the binding portion 900 of the book is located on the upper side and the book is vertically opened when the printed publication 1 is seen by aligning the printed publication 1 in the printing direction of the calendar pages A. Namely, the calendar numbers of the calendar pages A are oriented to be vertically opened when the printed publication is bound. By forming the calendar pages A to be opened vertically, the printed publication function as a wall hanging calendar when hooked on the wall using the hook holes 900.

The calendar pages A can be replaced with various guide pages. The guide pages are formed by repeating, serially publishing, or continuing contents selected from the group consisting of an advertisement guide, a countdown number, a photograph, a map, a drawing, a picture and a text. The contents are formed by one or a plurality of contents included in the above described group. The advertisement guide is a media for the advertising agency to collect the advertisements and for the advertiser to publish the advertisements. The countdown number is, for example, a number for counting down day-by-day until the date to hold the event such as the Olympics. If the countdown number is printed on the guide page while being combined with the photograph or the like, a similar function as a daily calendar can be exhibited.

FIG. 2 is a drawing showing the layout format C of the advertisement pages. The layout format C is a format preliminarily prepared for determining a page layout. For example, a position and a content to be laid out in the advertisement pages B are determined. The layout format C is stored in a layout device (layout format device) D. An arrangement of the advertisement page B is determined by assigning the advertisements to the layout format C on the layout device D. Note that the layout device D is a device for creating a printing data by laying out advertisements A on the layout format C to lay out the pages. In DTP (Desktop Publishing), a computer serves as the layout device D since the layout operation is performed on the computer. In addition, conventionally known various typesetting devices are included in the layout device D. The layout device D will be explained later in detail.

The layout format C shown in FIG. 2 is a format for assigning four advertisements on one page. Thus, four advertisement frames 200 for assigning the advertisements are laid out. The frame number 300 for specifying the advertisement frame is assigned to each of the advertisement frames 200. Furthermore, page numbers 600 for identifying the page, Internet addresses 700 of web sites to be in association with the advertisements, cut lines 800 for separating each of the advertisements, and hook holes 850 are also laid out on the layout format C.

The lower left advertisement frame 200 in the layout format C shown in FIG. 2 shows a state that the advertising material 100 of the advertising sponsor is laid out on the advertisement frame 200. The frame number 300 corresponding to the position to place the advertising material 100 is assigned to the advertising material 100. Thus, the advertising material 100 is assigned to the advertisement frame 200 having the corresponding frame number 300. Once the advertising material 100 is laid out on the advertisement frame 200, the frame number 300 is displayed on the layout format C as the advertisement number 400.

Note that the number and the position of advertisements to be placed on one page are not limited to the example of FIG. 2. In addition, the advertisement frames 200 of various sizes can be arranged in combination.

As an example of the advertising material 100, advertisements of magazines or books can be considered. In this case, the advertisement data is created based on a book title, an ISBN number, an author name, a publishing company, a content explanation, a price or the like of the advertisements. The created advertisement data is inserted into the advertisement frame 200 of the layout format C based on the frame number 300. The printed publication 1 is formed while the frame number 300 is displayed as the advertisement number 400 and the number (e.g., ISBN number) for identifying the book is displayed. Because of this, the users can order the commodity by using the ISBN number for identifying the book or the advertisement number.

As another example of the advertising material 100, job offer advertisements of the company or the store can be considered. In this case, the advertisement data is created based on a trade name, a business category, a job, an adoption condition, a recruitment number or the like of the company or the store. The created advertisement data is inserted into the advertisement frame 200 of the layout format C based on the frame number 300. The printed publication 1 is formed while the frame number 300 is displayed as the advertisement number 400 and the recruitment number is displayed. Because of this, the recruitment information can be identified by the advertisement number or the recruitment number.

As another example of the advertising material 100, the event information such as the store/business-opening day, the anniversary day, the store/business closing day or the like of the company or the store can be considered. In this case, the advertisement data is created based on the date of the event and the event information held on the date.

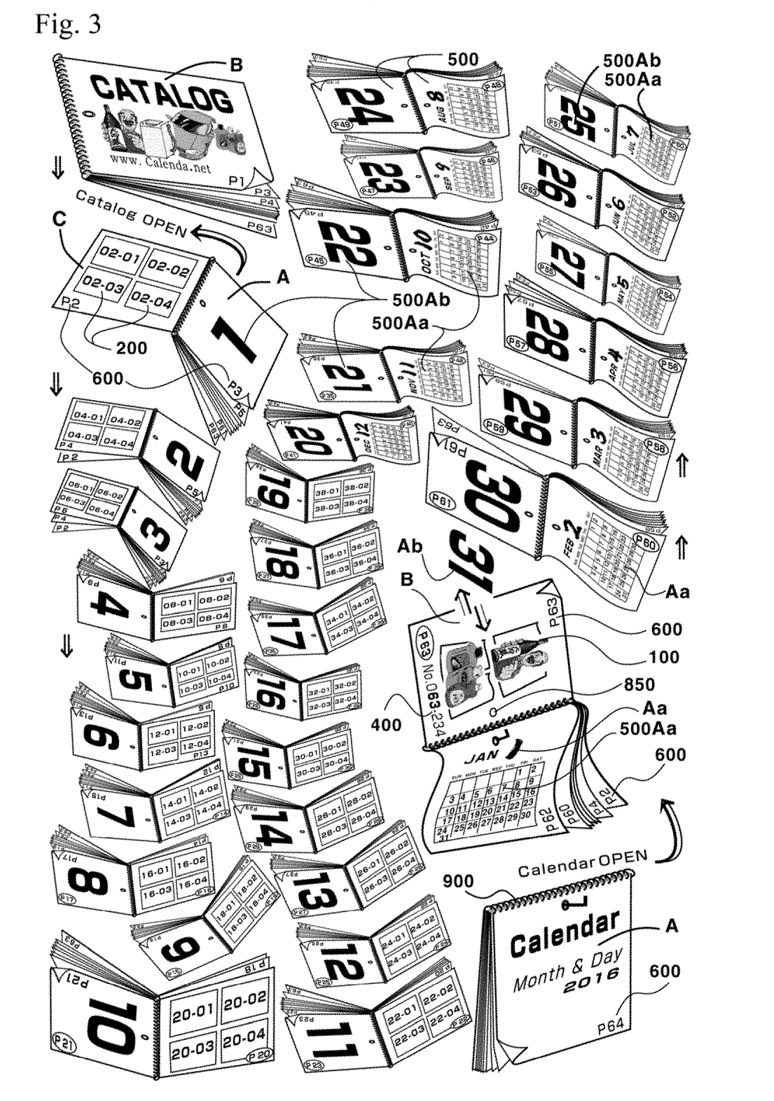

FIG. 3 is a drawing showing an example of a page layout of the calendar pages A and the advertisement pages B.

As shown in FIG. 3, P1 is the front page of the advertisement pages B, and P64 is the front page of the calendar pages A. The front pages are provided on both the front and back of the printed publication 1. Thus, the printed publication 1 is formed as a booklet to be started from both the front and back. The cover page of the advertisement pages B is printed in a direction of arranging the binding portion 900 of the printed publication 1 at the left side. Therefore, the printed publication 1 is bound to be laterally opened when the printed publication 1 is seen from the cover page side of the advertisement pages B. Note that the binding portion 900 can be arranged at the right side by rotating the printed publication 1 by 180°. The cover page of the calendar pages A is printed in a direction of arranging the binding portion 900 of the book at the upper side. Therefore, the printed publication 1 is bound to be vertically opened when the printed publication 1 is seen from the cover page side of the calendar pages A.

The daily calendar pages AB of 1st to 30th days are printed on odd pages of P3 to P61. The daily calendar pages AB are printed in a direction of arranging the binding portion 900 at the upper side when the book is bound. Although the advertisement page B is printed on P63, P63 becomes the calendar page of the 31st day when printing the daily calendar pages AB until 31st day. The advertisement pages B are printed on even pages of P2 to P38. In the present embodiment, four advertisements are printed on each page. The advertisement pages B are printed in a direction of arranging the binding portion 900 at the left side when the book is bound. The monthly calendar pages AA are printed on the even pages of P40 to P62. The monthly calendar pages AA are printed in a direction of arranging the binding portion 900 at the upper side when the book is bound.

When the book is printed, gathered and bound as explained above, a combination of two facing pages is one of a combination of the daily calendar pages AB and the advertisement pages B, a combination of the monthly calendar pages AA and the advertisement pages B, or a combination of the daily calendar pages AB and the monthly calendar pages AA. Namely, the advertisement pages B are printed on the reverse side of the calendar pages AA or the calendar pages AB. Note that the advertisement pages B can be formed on both the front and back sides in some pages.

When only the even pages are viewed as a laterally opened booklet in order from P2, the printed publication 1 functions as a catalog booklet on which the advertisement pages B are continuously printed. When only the odd pages are viewed as a vertically opened booklet in order from P3, the printed publication 1 functions as a daily calendar. When only the odd pages are viewed as a vertically opened booklet in reverse order from P62, the printed publication 1 functions as a monthly calendar.

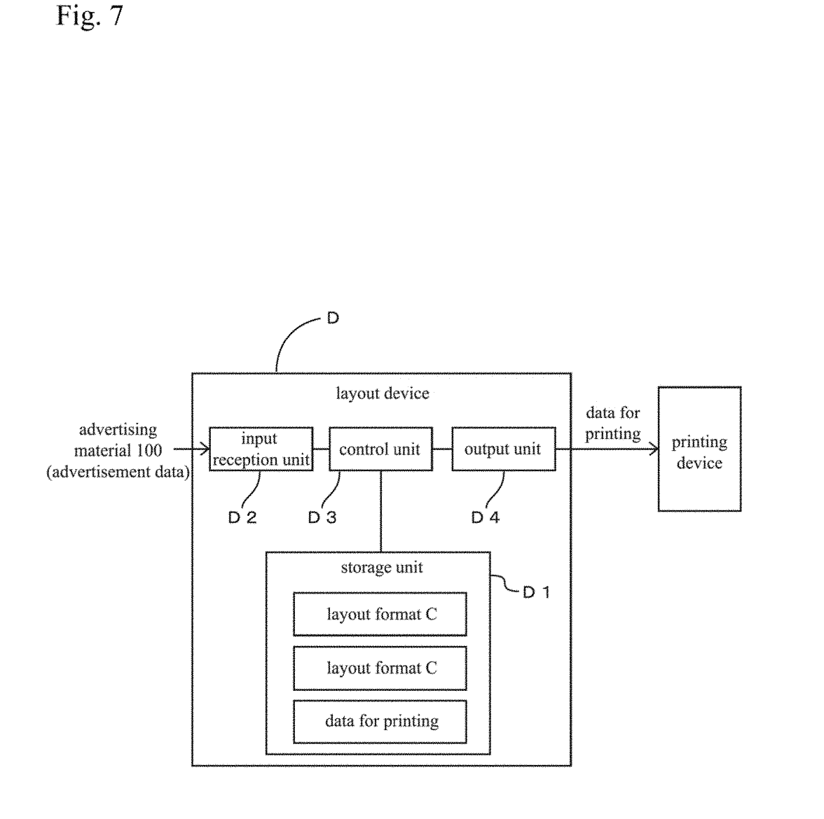

FIG. 7 is a block diagram schematically showing the layout device D for laying out a plurality of advertising material data on the printed publication 1 using the layout format C. The layout device D includes a storage unit D1 for storing the layout format C and the like, an input reception unit D2 for receiving input operations of the operator, a control unit D3 for controlling storage, input and the like, and an output unit D4 for outputting the data to external devices such as a printing device. The storage unit D1 preliminarily stores the layout format C in which the calendar pages A, the advertisement frames 200 and the like are laid out. When a plurality of layout formats C is stored, the layout format C can be arbitrarily selected in accordance with the number of pages, the content of the advertisement or the like of the printed publication 1 to be created. The stored layout format C can be edited to change the appearance of the layout format C and a new layout format C can be stored. The storage unit D1 is formed, for example, by memory devices such as a RAM and a ROM or external storage devices such as a hard disk.

When the order of the advertisement is received from the advertising sponsor, the operator performs a data input operation to the input reception unit D2 on the layout device D by using input devices such as a keyboard and a mouse. Thus, the advertising material 100 is laid out on the layout format C. As explained above, the advertisement frame 200 to place the advertising material 100 can be identified by the frame number 300 Thus, the operator only assigns the frame number 300 to the advertising material 100 and then the advertising material 100 is laid out on the corresponding advertisement frame 200 by the control unit D3. The control unit D3 is formed, for example, by a CPU of the computer. The layout format C on which the advertising material 100 is laid out is stored in the storage unit D1 as a data for printing, and output from the output unit D4 to the printing device or the like when needed.

### Second Embodiment

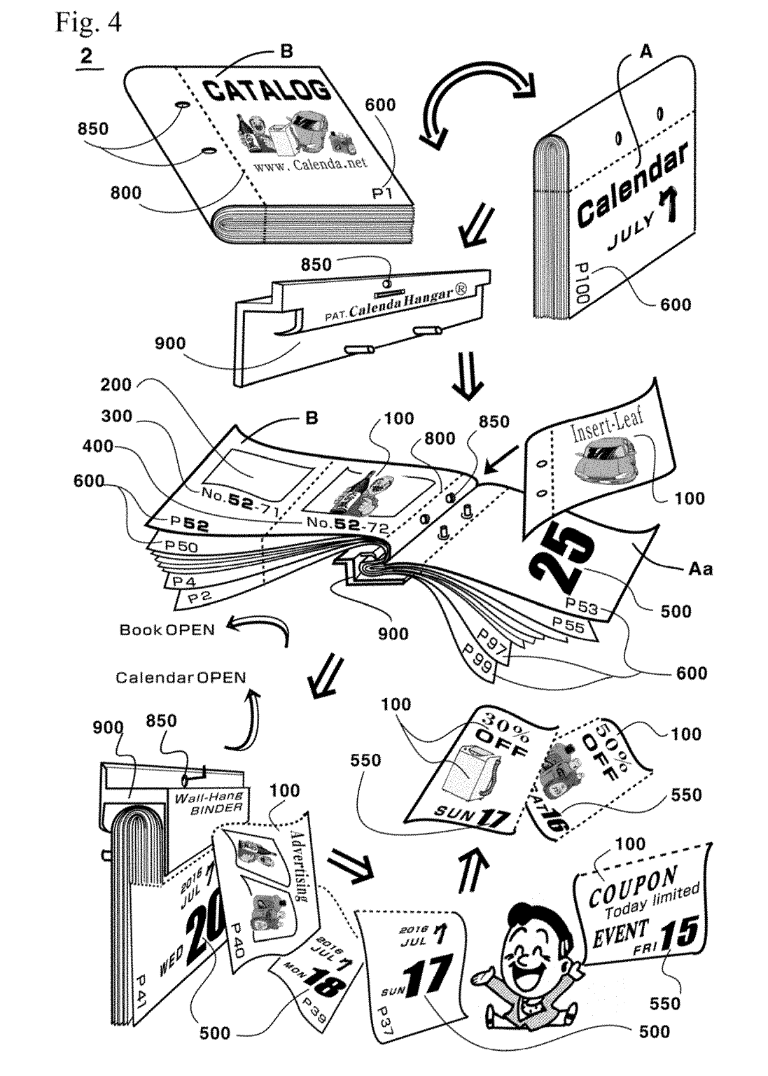

FIG. 4 is a drawing showing an example where calendar numbers of the calendar pages B and advertisement date numbers are in association with each other and printed on both sides of the paper in a printed publication 2 concerning the second embodiment. The second embodiment will be explained by an example of the saddle stitched printed publication 2 using a wire and a wall hanging-type file binder shown in Patent Document 2 as the binding portion 900.

Since the second embodiment is bound by saddle stitching, P1 and P64 are printed on the same paper and P2 and P63 are printed on the reverse surface of P1 and P64. Similarly, the following pages are formed by printing P3 and P62 and printing P4 and P61 on the reverse surface of P3 and P62. After printed, the papers are overlapped, folded at the center and bound by a wire or the like to form the printed publication 2. The calendar pages AB are laid out on the even pages and the advertisement pages B are laid out on the odd pages. Thus, the advertisement pages B are printed on the reverse surface of the daily calendar pages AB. The advertisement pages B can be formed on both sides in some pages.

The cut lines 800 are formed on the printed publication 2 so that a part of the page can be cut and removed. On the advertisement pages AB, in addition to the items explained in the first embodiment, advertisement date numbers (numbers of advertisement date) 550 are printed. The advertisement date numbers 550 are, for example, a selling date/publication date of commodity or service, a deadline for applying the job offering advertisement for correcting human resources, and the event information such as the anniversary day of the store. In addition, the advertisement date numbers 550 can be an expiration date of a discount coupon. The advertisement date numbers 550 indicated on the advertisement pages B and the calendar numbers 500 indicated on the calendar pages AB are in association with each other. The advertisement date numbers 550 and the calendar numbers 500 can be associated by specifying the same date or by specifying the calendar numbers 500 predetermined period prior to the advertisement date numbers 550. Since the advertisement date numbers 550 and the calendar numbers 500 are in association with each other, the users have more opportunity to see the advertisement corresponding to the calendar. In addition, since the page can be cut and removed by the cut lines 800, the advertising material 100 corresponding to the calendar can be used by cutting it.

### Third Embodiment

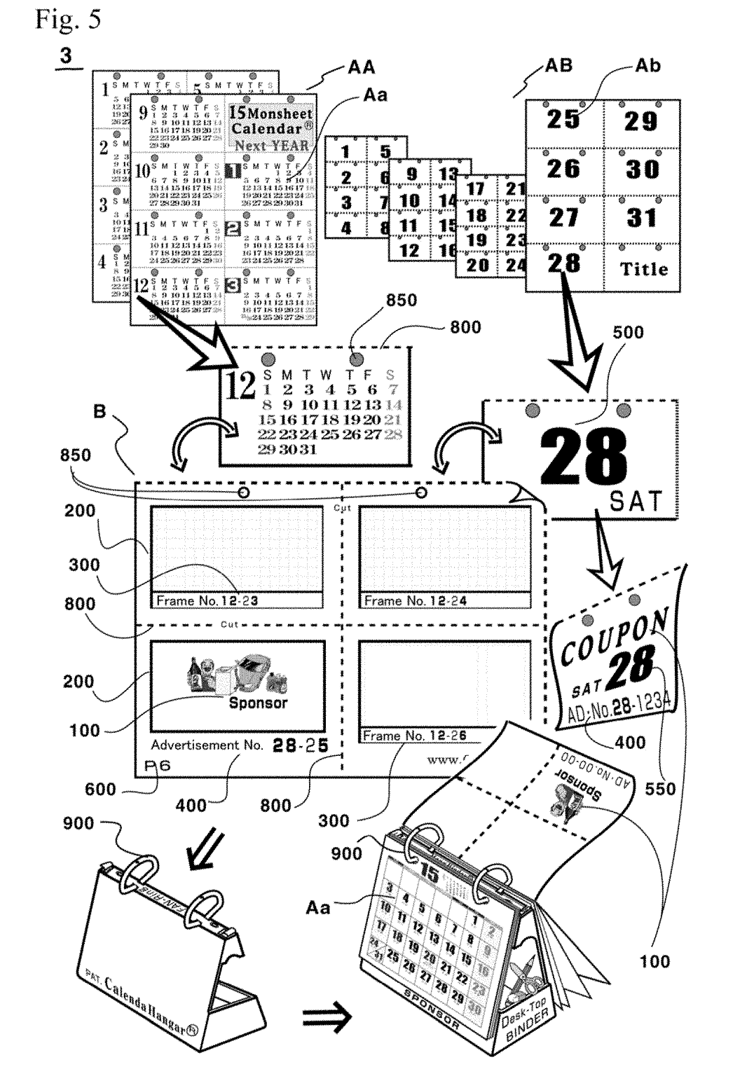

FIG. 5 is a drawing showing a relation among the calendar numbers of the calendar pages, the advertisements of the advertisement pages and cut lines in a printed publication 3 concerning the third embodiment. In the example shown in FIG. 5, the desktop-type file binder shown in Patent Document 3 is used as the binding portion 900.

In the third embodiment, the advertisement pages B are printed on the reverse surface of the monthly calendar pages AA or the daily calendar pages AB. The printed paper is cut into eight parts. Thus, eight calendar pages AA or daily calendar pages AB are created from one paper. On an upper part of each of the calendar pages which are cut into eight parts, two hook holes 850 are formed. Thus, each of the pages can be attached to the file binder. On the reverse surface of each page, four advertisement frames 200 are arranged. Thus, four advertising materials 100 can be placed on one sheet of paper. In addition, cut lines 800 are formed to cross from one end of the page to the other end so that each of the advertisement frames 200 can be individually cut and removed. The paper can be cut individually for each of the advertisements by the cut lines 800.

Same as the second embodiment, the advertisement date numbers 550 indicated on the advertisement pages and the calendar numbers 500 indicated on the calendar pages AA or the calendar pages AB are in association with each other. Since the advertisement date numbers 550 and the calendar numbers 500 are in association with each other, the users have more opportunity to see the advertisement corresponding to the calendar. In addition, since the page can be cut and removed by the cut lines 800, the advertising material 100 corresponding to the calendar can be used by cutting it.

### Fourth Embodiment

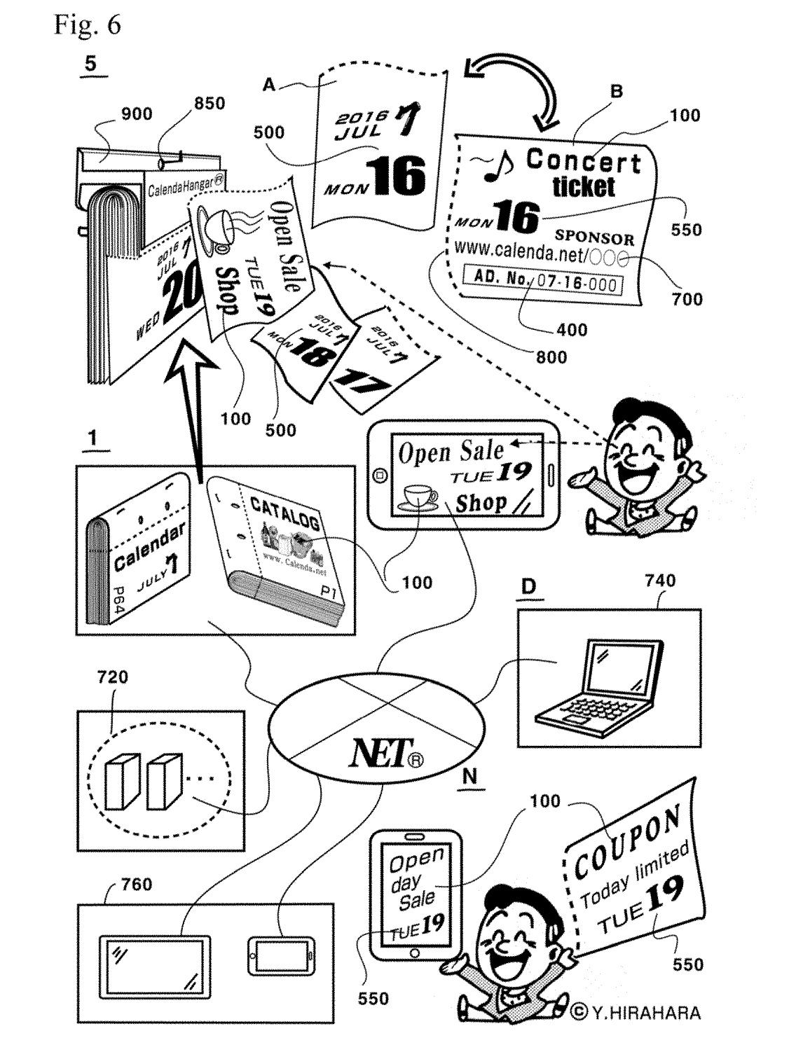

FIG. 6 is a drawing showing a distribution system (web distribution system) S that mediates the advertisement of the printed publication 1 with the advertisement delivered on the Internet using the calendar numbers. The distribution system S is formed by the printed publication 1, Internet server 720, sponsor side terminals 740 and user side terminals 760.

The Internet server 720 includes a network interface for connecting to a network N, a storage unit for storing the calendar data or the like, and a control unit for controlling the interface and the storage unit, for example. The Internet server 720 receives access from the sponsor side terminals 740 and the user side terminals 760 via the network N.

A server manager prepares the calendar data in the storage unit of the Internet server 720. The calendar data includes 365 calendar numbers and cells corresponding respectively to the calendar numbers so that the event information can be input to the cells. The server manager gives an authority of inputting the event information to the calendar data to the advertising sponsors.

The sponsor side terminal 740 includes a network interface for connecting to a network N, an input reception unit for receiving operations of the advertising sponsors, and a control unit for controlling the above described units. The advertising sponsor having the authority inputs the event information such as the anniversary day corresponding to the advertisement page B of the printed publication 1 to the calendar data stored in the Internet server 720 from the sponsor side terminals 740 via the network N.

The Internet address 700 is printed on the advertisement pages B of the printed publication 1. The user side terminal 760 includes a network interface for connecting to a network N, an input reception unit for receiving operations of the users, and a control unit for controlling the above described units. The users input the Internet address 700 in the user side terminal 760. Thus, the users can view the calendar data stored in the Internet server 720 via the network N. The event information input from the sponsor side terminals 740 are indicated on the calendar data. Consequently, the users can view the event information corresponding to the advertisement page B on the user side terminal 760.

Same as the second embodiment and the third embodiment, the advertisement date numbers 550 indicated on the advertisement pages and the calendar numbers 500 indicated on the calendar pages AA or the calendar pages AB are in association with each other. In addition, the content of the advertisement indicated in the calendar pages A and the event information input to the calendar data are in association with each other. Furthermore, the date of the event information, the calendar number of the calendar page and the calendar number of the calendar data are in association with each other.

Consequently, the user having an interest in the advertising material 100 placed on the advertisement page B can access the calendar data via the network N and obtain more detail information about the advertising material 100. In addition, when the discount coupon or the like is included in the advertisement page B, the user can join the event while the corresponding advertisement page B is cut and removed.

The advertisement number 400 printed on the printed publication 1 can be uploaded on the Internet server 720 as an order number for trading the advertisement and the commodity. Consequently, when the Internet server 720 is viewed from the user side terminals 760, the order number on the Internet server 720 can be identified from the advertisement number 400 of the advertising material or the commodity printed on the advertisement page B of the printed publication 1.

The information input to the calendar data is not limited to the event information. Various information related to the advertisements printed on the printed publication 1 can be input to the calendar data so as to be viewed by the users. For example, it is beneficial to input the information related to the advertisements of the magazines and the books or the job offer advertisements. Note that it is also possible to input the information related to the printed publication 2 and the printed publication 3 without limited to the printed publication 1.

### DESCRIPTION OF REFERENCE SIGNS

A: calendar pages
AA: monthly calendar pages
AB: daily calendar pages
B: advertisement pages
D: layout device
N: network
S: distribution system
100: advertising material
200: advertisement frame
300: frame numbers
400: advertisement numbers
500: calendar numbers
550: advertisement date numbers
600: page numbers
700: Internet address
720: Internet server
740: sponsor side terminals
760: user side terminal
800: cut lines
850: hook holes
900: binding portion

1. A layout device of a calendar and an advertisement for laying out a plurality of advertising material data on a printed publication having 12 or more pages, the layout device comprising:
a storage unit configured to store a layout format for laying out the advertising material data;
an input reception unit configured to receive a data input operation of an operator; and
a control unit configured to lay out the advertising material data on the layout format according to the data input operation, wherein
the printed publication is composed of a calendar page and an advertisement page, calendar numbers of at least one month of a daily calendar, a plurality of months of a monthly calendar or both of the daily calendar and the monthly calendar being printed on the calendar page, an advertisement of commodity or service being printed on the advertisement page,
the advertisement page is laid out on a reverse side of the calendar page or both sides of a paper on which the calendar page is not printed,
the layout format includes a page number for gathering the printed publication, a frame-shaped advertisement frame for laying out the advertisement on the advertisement page, and a frame number for identifying the advertisement frame,
the advertisement frame is provided in plural number in the layout format for enabling to receive an order of placing a plurality of advertisements from an advertising sponsor,
the page number is included in a part of the frame number so that the page number and the frame number are in association with each other by numbering,
the frame number is converted into an advertisement number and arranged on the layout format so as to be printed on the advertisement page when the advertising material data is laid out on the advertisement frame,
the layout format is formed so that the advertising material of the advertisement page is oriented to be laterally opened when the printed publication is bound,
the layout format is formed so that the calendar numbers of the calendar page are oriented to be vertically opened when the printed publication is bound,
the advertisement page is laid out on the reverse side of the calendar page,
the advertisement page includes at least one number of an advertisement date and an event information held on the advertisement date, the advertisement date being selected from a group of a selling date of the commodity or the service, a store/business-opening day of a company or a store, an anniversary day of the company or the store, and a store/business closing day of the company or the store, and
the number of the advertisement date and the calendar number are in association with each other between the advertisement page and the calendar page which are printed on both sides of the paper.

2. A web distribution system, comprising:
the layout device according to claim 1;
an Internet server;
a sponsor side terminal; and
a user side terminal, wherein
a calendar data having 365 cells of the calendar number is stored in the Internet server,
the event information can be input to the cells from the sponsor side terminal,
a content of the advertisement described in the advertisement page and the event information input to the cells are in association with each other,
a date of the event information, the calendar number displayed on the calendar page and the calendar number stored in the Internet server are associated with each other, and
the event information can be browsed from the user side terminal.

3. The web distribution system according to claim 2, wherein
the advertisement number is uploaded on the Internet server as an order number for trading the advertisement and the commodity, and
the order number of advertising material and the commodity can be browsed from the user side terminal.

4. A printed publication printed and bound into 64 pages printed on both sides of 32 sheets of paper,
the printed publication is composed of a calendar page and an advertisement page, calendar numbers of at least one month of a daily calendar, a plurality of months of a monthly calendar or both of the daily calendar and the monthly calendar being printed on the calendar page, an advertisement of commodity or service being printed on the advertisement page,
the advertisement page is printed on a reverse side of the calendar page or both sides of the paper on which the calendar page is not printed,
the advertisement page is laid out based on a layout format for laying out the advertisement,
the layout format includes a page number for gathering the printed publication, a frame-shaped advertisement frame for laying out the advertisement on the advertisement page, and a frame number for identifying the advertisement frame,
the advertisement frame is provided in plural number in the layout format for enabling to list the commodity or the service,
the page number is included in a part of the frame number so that the page number and the frame number are associated with each other,
the frame number is printed on the advertisement page as an advertisement number,
the printed publication is laterally opened by arranging a binding portion for binding one end of the printed publication at a left side or a right side when a reader of the advertisement page views the printed publication in accordance with a printing direction of the advertisement page,
the printed publication is vertically opened by arranging a binding portion for binding one end of the printed publication at an upper side when the reader of the advertisement page views the printed publication in accordance with a printing direction of the calendar page,
the binding portion of the printed publication is bound by using at least one of a file binder, a wire ring, an adhesive liquid and a wire,
the layout format is formed so that the calendar numbers of the calendar page are oriented to be vertically opened when the printed publication is bound,
the advertisement page is laid out on the reverse side of the calendar page,
the advertisement page includes at least one number of an advertisement date and an event information held on the advertisement date, the advertisement date being selected from a group of a selling date of the commodity or the service, a store/business-opening day of a company or a store, an anniversary day of the company or the store, and a store/business closing day of the company or the store, and
the number of the advertisement date and the calendar number are associated with each other between the advertisement page and the calendar page which are printed on both sides of the paper.

5. The layout device of the calendar and the advertisement according to claim 1, wherein
the calendar page of the printed publication is replaced with a guide page composed of at least one of an advertisement guide, a countdown number, a photograph, a map, a drawing and a text.
